(19) United States
(12) Patent Application Publication
(10) Pub. No.: US 2025/0309392 A1
(43) Pub. Date: Oct. 2, 2025

(54) METHOD FOR PRODUCING REGENERATED POSITIVE ELECTRODE

(71) Applicant: HONDA MOTOR CO., LTD., Tokyo (JP)

(72) Inventors: Kenta Urata, Wako-shi (JP); Takashi Higono, Wako-shi (JP); Taichiro Sato, Wako-shi (JP); Shuichi Kazuno, Wako-shi (JP); Takeshi Muro, Wako-shi (JP); Tomohiro Inoue, Wako-shi (JP); Sae Ishihara, Wako-shi (JP)

(21) Appl. No.: 19/091,965

(22) Filed: Mar. 27, 2025

(30) Foreign Application Priority Data
Mar. 29, 2024 (JP) 2024-057347
Feb. 18, 2025 (JP) 2025-024413

(51) Int. Cl. H01M 10/54; B09B 3/32; B09B 3/70; B09B 3/80; B09B 101/16; H01M 4/02; H01M 4/04

(52) U.S. Cl. CPC H01M 10/54; B09B 3/32; B09B 3/70; B09B 3/80; H01M 4/043; H01M 4/0459; B09B 2101/16; H01M 2004/028

(57) ABSTRACT

A method for producing a regenerated positive electrode in a lithium ion secondary battery including a laminate having a positive electrode, either one of a separator and a solid electrolyte layer, and a negative electrode, the method including: washing the laminate retrieved from the lithium ion secondary battery with an organic solvent; retrieving the positive electrode from the laminate washed with the organic solvent; and subjecting the retrieved positive electrode to a regeneration process.

### CROSS-REFERENCE TO RELATED APPLICATIONS

Priority is claimed on Japanese Patent Application No. 2024-057347, filed Mar. 29, 2024 and Japanese Patent Application No. 2025-024413, filed Feb. 18, 2025, the contents of which are incorporated herein by reference.

### BACKGROUND OF THE INVENTION

### Field of the Invention

The present invention relates to a method for producing a regenerated positive electrode.

### Description of Related Art

In recent years, research and development has been conducted on the reuse of lithium ion secondary batteries, which contribute to energy efficiency, in order to ensure that more people have access to affordable, reliable, sustainable and advanced energy.

For example, Patent Document 1 discloses a method for regenerating an electrode of a lithium ion battery, which includes: a step of treating at least one of electrodes, among positive and negative electrodes, of a used lithium ion secondary battery with a polar solvent; a step of drying this solvent-treated electrode; and a step of reinjecting a liquid into the battery having this dried electrode.

For example, Patent Document 2 discloses a method for reusing a negative plate for a nonaqueous electrolyte secondary battery, which is characterized by retrieving a negative plate from a nonaqueous electrolyte secondary battery using a carbon material as a negative electrode active material, washing the aforementioned plate with a liquid containing water, and reusing it after drying.

### PRIOR ART DOCUMENTS

### Patent Documents

[Patent Document 1] Japanese Unexamined Patent Application, First Publication No. 2012-022969

[Patent Document 2] Japanese Unexamined Patent Application, First Publication No. 2006-228510

### SUMMARY OF THE INVENTION

### Problems to be Solved by the Invention

Incidentally, in the technology related to the reuse of secondary batteries such as that of Patent Document 1, although degraded products on the surface of the positive electrode active material of the positive electrode can be removed, the recovery from the increase in resistance is insufficient, and also the recovery from the capacitance decrease due to the reduction of lithium in the positive electrode cannot be achieved. Patent Document 2 does not disclose a method for reusing a positive electrode.

The present application aims to recover from the capacitance decrease due to the reduction of lithium in the positive electrode in order to solve the above problems.

### Means for Solving the Problem

In order to solve the above problems, the present invention includes the following aspects.

[1] A method for producing a regenerated positive electrode in a used lithium ion secondary battery including a laminate having a positive electrode, either one of a separator and a solid electrolyte layer, and a negative electrode, the method comprising: washing said laminate retrieved from said lithium ion secondary battery with an organic solvent; retrieving said positive electrode from the laminate washed with said organic solvent; and subjecting said retrieved positive electrode to a regeneration process.

According to the above aspect, by washing the positive electrode with an organic solvent, it is possible to recover from the increase in resistance due to a lithium-containing thin film formed on the positive electrode. In addition, by washing the laminate, the washing with the organic solvent can be performed with a small facility, and the amount of organic solvent used or the amount of waste liquid is reduced, making it possible to perform the washing more efficiently or economically.

[2] A method for producing a regenerated positive electrode in a used lithium ion secondary battery including a laminate having a positive electrode, either one of a separator and a solid electrolyte layer, and a negative electrode, the method comprising: washing said positive electrode retrieved from said lithium ion secondary battery with an organic solvent; and subjecting said the positive electrode washed with said organic solvent to a regeneration process.

According to the above aspect, by washing the positive electrode with an organic solvent, it is possible to recover from the increase in resistance due to a lithium-containing thin film formed on the positive electrode.

[3] The method for producing a regenerated positive electrode according to [1] or [2], wherein the aforementioned organic solvent is an aprotic polar solvent.

According to the above aspect, the effect of recovering from the increased resistance due to the lithium-containing thin film formed on the positive electrode is further enhanced.

[4] The method for producing a regenerated positive electrode according to any one of [1] to [3], wherein the aforementioned organic solvent is at least one organic solvent selected from the group consisting of a ketone and a carbonate.

According to the above aspect, the effect of recovering from the increased resistance due to the lithium-containing thin film formed on the positive electrode is further enhanced.

[5] The method for producing a regenerated positive electrode according to any one of [1] to [4], wherein the aforementioned organic solvent is at least one organic solvent selected from the group consisting of acetone and dimethyl carbonate.

According to the above aspect, the effect of recovering from the increased resistance due to the lithium-containing thin film formed on the positive electrode is further enhanced.

[6] The method for producing a regenerated positive electrode according to any one of [1] to [5], wherein the aforementioned regeneration process includes pressing the aforementioned positive electrode.

According to the above aspect, by pressing the positive electrode, it is possible to recover from the increase in resistance due to the decrease in the degree of adhesion between the particles and the like of the positive electrode active material.

[7] The method for producing a regenerated positive electrode according to [6], wherein the aforementioned regeneration process further includes doping the aforementioned pressed positive electrode with lithium ions, and the doping of the aforementioned lithium ions is performed by discharging in an electrolytic solution using a lithium electrode as a counter electrode.

According to the above aspect, by doping the aforementioned pressed positive electrode with lithium ions, it is possible to recover from the capacitance decrease due to the reduction of lithium in the positive electrode. In addition, by performing the pressing of the positive electrode and the doping of the lithium ions in this order, the doping of the lithium ions becomes uniform. Furthermore, by performing the pressing of the positive electrode and the doping of the lithium ions in this order, a regenerated positive electrode can be produced more efficiently.

[8] The method for producing a regenerated positive electrode according to any one of [1] to [7], wherein the aforementioned laminate is wound.

According to the above aspect, the recovery effects in the other aspects described above can be maximized.

[9] The method for producing a regenerated positive electrode according to [2] to [8], further comprising subjecting the positive electrode to a regeneration process before washing with the organic solvent.

According to the above aspect, by subjecting the positive electrode to a regeneration process and washing the regenerated positive electrode, it is possible to recover from the capacitance decrease due to the reduction of lithium in the positive electrode. In addition, it is possible to recover from the increase in resistance due to a lithium-containing thin film formed on the positive electrode.

### Effects of the Invention

According to each of the aspects of the present invention described above, it is possible to recover from the capacitance decrease due to the reduction of lithium in the positive electrode. In addition, it is possible to reuse secondary batteries more efficiently. Further, this in turn contributes to energy efficiency.

### BRIEF DESCRIPTION OF THE DRAWINGS

FIG. 1 is a schematic cross-sectional view showing an example of a layer configuration of a laminate in a lithium ion secondary battery according to one embodiment of the present invention.

FIG. 2 is a schematic cross-sectional view showing an example of a layer configuration of a laminate in a lithium ion secondary battery according to another embodiment of the present invention.

FIG. 3 is a flow chart of a method for producing a regenerated positive electrode according to a first embodiment of the present invention.

FIG. 4 is a flow chart of a method for producing a regenerated positive electrode according to another first embodiment of the present invention.

FIG. 5 is a diagram showing the results of measuring the capacity of the secondary batteries in Examples 1 to 3 and Comparative Examples 1 to 4.

FIG. 6 is a diagram showing the results of measuring the resistance of the positive electrode in Examples 1 to 3 and Comparative Examples 1 to 4.

### DETAILED DESCRIPTION OF THE INVENTION

Hereinafter, an embodiment of the present invention will be described in detail, however the following description is an example of the embodiment of the present invention, and the present invention is not limited to these contents and can be modified and carried out within the scope of the gist thereof.

A method for producing a regenerated positive electrode according to the present embodiment is a method for producing a regenerated positive electrode in a lithium ion secondary battery having a laminate including a positive electrode, either one of a separator and a solid electrolyte layer, and a negative electrode. That is, the lithium ion secondary battery of the present embodiment includes a lithium ion secondary battery in which the electrolyte is liquid (hereinafter also referred to as a “liquid electrolyte lithium ion secondary battery”) and a lithium ion secondary battery in which the electrolyte is solid (hereinafter also referred to as an “all-solid-state lithium ion secondary battery”).

The method for producing a regenerated positive electrode includes: washing the aforementioned laminate with an organic solvent (hereinafter also referred to as a “washing process”); retrieving the aforementioned positive electrode from the laminate washed with the aforementioned organic solvent; and subjecting the aforementioned retrieved positive electrode to a regeneration process.

In another embodiment, a method for producing a regenerated positive electrode includes washing said positive electrode retrieved from said lithium ion secondary battery with an organic solvent; and subjecting said the positive electrode washed with said organic solvent to a regeneration process.

### Lithium Ion Secondary Battery

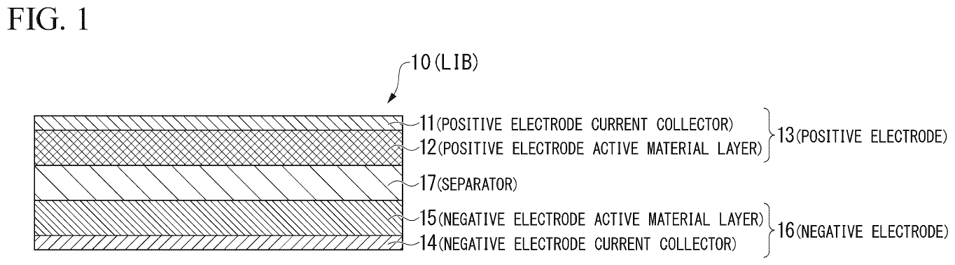

FIG. 1 is a schematic cross-sectional view showing an example of a layer configuration of a laminate in a lithium ion secondary battery (liquid electrolyte lithium ion secondary battery) according to one embodiment.

A lithium ion secondary battery 10 (LIB) is composed of a positive electrode 13, a separator 17, and a negative electrode 16 stacked in this order. The positive electrode 13 is composed of a positive electrode current collector 11 and a positive electrode active material layer 12 provided on the surface of the positive electrode current collector 11. It should be noted that the positive electrode active material layer 12 is provided on only one side of the positive electrode current collector 11 in FIG. 1, however it may be provided on both sides. The negative electrode 16 is composed of a negative electrode current collector 14 and a negative electrode active material layer 15 provided on the surface of the negative electrode current collector 14. It should be noted that the negative electrode active material layer 15 is provided on only one side of the negative electrode current collector 14 in FIG. 1, however it may be provided on both sides. Further, only one positive electrode 13 and one negative electrode 16 are respectively included in FIG. 1, however an electrode group in which a plurality of positive electrodes 13 and negative electrodes 16 are stacked alternately may be used. Also in this case, a separator 17 is installed between the positive electrode 13 and the negative electrode 16.

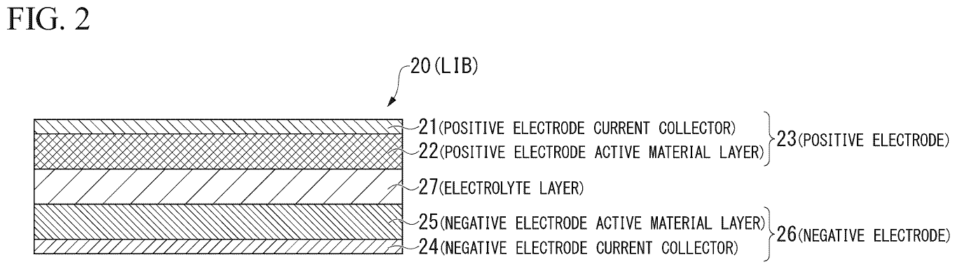

FIG. 2 is a schematic cross-sectional view showing an example of a layer configuration of a laminate in a lithium ion secondary battery (all-solid-state lithium ion secondary battery) according to another embodiment.

A lithium ion secondary battery 20 (LIB) is composed of a positive electrode 23, a solid electrolyte layer 27, and a negative electrode 26 stacked in this order. The positive electrode 23 is composed of a positive electrode current collector 21 and a positive electrode active material layer 22 provided on the surface of the positive electrode current collector 21. It should be noted that the positive electrode active material layer 22 is provided on only one side of the positive electrode current collector 21 in FIG. 2, however it may be provided on both sides. The negative electrode 26 is composed of a negative electrode current collector 24 and a negative electrode active material layer 25 provided on the surface of the negative electrode current collector 24. It should be noted that the negative electrode active material layer 25 is provided on only one side of the negative electrode current collector 24 in FIG. 2, however it may be provided on both sides. Further, only one positive electrode 23 and one negative electrode 26 are respectively included in FIG. 2, however an electrode group in which a plurality of positive electrodes 23 and negative electrodes 26 are stacked alternately may be used. Also in this case, a solid electrolyte layer 27 is installed between the positive electrode and the negative electrode.

### (Positive Electrode Active Material Layer)

The positive electrode active material layer 12 (22) contains a positive electrode active material, a conductive auxiliary agent, and a binder. It should be noted that when the positive electrode active material is conductive, the positive electrode active material layer may not contain a conductive auxiliary agent.

The positive electrode active material is not particularly limited as long as it is capable of storing and releasing lithium ions. Examples of the positive electrode active material include a lithium nickel oxide (for example, LiNiO₂), a lithium cobalt oxide (for example, LiCoO₂), a lithium nickel cobalt oxide, a lithium nickel cobalt manganese oxide, LiFePO₄, LiMn₁₋ₓFeₓPO₄, LiMnPO₄, LiCoPO₄, and LiNiPO₄. The positive electrode active material preferably contains one or more selected from the group consisting of manganese, nickel, and cobalt.

The conductive auxiliary agent assists in the formation of a conductive path between the positive electrode active material and the positive electrode current collector 11 (21). The conductive auxiliary agent is not particularly limited as long as it is conductive, and examples thereof include carbon black such as acetylene black, carbon nanotubes, and graphite such as artificial graphite.

The binder binds the positive electrode active material, the conductive auxiliary agent, and the positive electrode current collector 11 (21), respectively. Examples of the binder include polyvinylidene fluoride (PVDF), polytetrafluoroethylene (PTFE), polyamide (PA), polyimide (PI), polyacrylic acid and copolymers thereof, polyamideimide (PAI), polybenzimidazole, polyethersulfone (PES), maleic anhydride modified polypropylene, and mixtures thereof. The binder preferably contains a crystalline polymer having a melting point. The binder is preferably a polymer containing fluorine. Examples of the polymer containing fluorine include PVDF and PTFE.

### (Positive Electrode Current Collector)

Examples of the positive electrode current collector 11 (21) include a metal foil such as an aluminum foil, a stainless steel foil, and a nickel foil. A carbon coating layer may be formed on the positive electrode current collector 21. Further, the positive electrode current collector 11 (21) may also be processed into a mesh form.

### (Negative Electrode Active Material Layer)

The negative electrode active material layer 15 (25) contains a negative electrode active material, a conductive auxiliary agent, and a binder. It should be noted that when the negative electrode active material is conductive, the negative electrode active material layer may not contain a conductive auxiliary agent.

The negative electrode active material is not particularly limited as long as it is capable of storing and releasing lithium ions. Examples of the negative electrode active material include graphite (artificial graphite, natural graphite), amorphous carbon (hard carbon), mesocarbon microbeads, carbon fibers, and Si materials (silicon, Si alloys, and Si oxides).

The conductive auxiliary agent assists in the formation of a conductive path between the negative electrode active material and the negative electrode current collector 14 (24). The conductive auxiliary agent is not particularly limited as long as it is conductive, and examples thereof include carbon black such as acetylene black, carbon nanotubes, and graphite such as artificial graphite.

The binder binds the negative electrode active material, the conductive auxiliary agent, and the negative electrode current collector 14 (24), respectively. Examples of the binder include carboxymethyl cellulose, polyvinylidene fluoride, polytetrafluoroethylene, polyacrylic acid, fluororubbers, and diene-based rubbers such as styrene butadiene rubbers. The binder preferably contains a crystalline polymer having a melting point. The binder is preferably a polymer containing fluorine. Examples of the polymer containing fluorine include PVDF, PTFE, and fluororubbers.

Examples of the negative electrode current collector 14 (24) include a metal foil such as a copper foil, a stainless steel foil, and a nickel foil. A carbon coating layer may be formed on the negative electrode current collector 14 (24). Further, the negative electrode current collector 14 (24) may also be processed into a mesh form.

### (Electrode Tab)

In order to extract current to the outside of the battery, the positive electrode current collector 11 (21) and the negative electrode current collector 14 (24) described above may each be connected to an electrode tab (not shown). The electrode tab is electrically connected to these current collectors and is retrieved, for example, to the outside of an exterior body of the lithium ion secondary battery.

The material constituting the electrode tab is not particularly limited, and a known highly conductive material that has been conventionally used as an electrode tab is preferably used. The material constituting the electrode tab is preferably, for example, a metal material such as aluminum, copper, titanium, nickel, stainless steel, or an alloy thereof, and more preferably, aluminum, copper, and the like from the viewpoints of light weight, corrosion resistance, and high conductivity.

### (Exterior Body)

The above laminate is housed in an exterior body (not shown). In the case of a liquid electrolyte lithium ion secondary battery, the exterior body is filled with an electrolytic solution. As the exterior body, a known metal can case can be used, or a bag-shaped case using a laminate film containing aluminum that can cover a power generating element may be used. For the above laminate film, for example, a laminate film having a three layer structure formed by laminating polypropylene, aluminum, and nylon in this order, or the like can be used. From the viewpoints of excellent high output and cooling performance and suitable use for large equipment batteries for EVs and HEVs, a laminate film is desirable as the exterior body.

Positive and negative electrode terminal leads (both not shown) connected to the electrode tabs may also be used as necessary. Known materials can be used for materials of the positive and negative electrode terminal leads. It should be noted that parts retrieved from the exterior body are preferably covered with a heat-resistant insulating heat-shrinkable tube or the like to prevent contact with peripheral devices, wiring, or the like, causing electrical leakage and adversely affecting the product (for example, automobile parts, especially electronic devices, and the like). Further, in a wound type lithium ion secondary battery, a terminal may be formed using, for example, a cylindrical can (metal can) instead of the electrode tab.

### (Electrolytic Solution)

The electrolytic solution contains an electrolyte and an organic solvent. The electrolyte may be selected from electrolytes known in the art, and examples thereof include lithium salts such as LiClO₄, LiPF₆, LiAsF₆, LiSbF₆, LiBF₄, LiCF₃SO₃, LiN(SO₂CF₃)₂, LiN(SO₂C₂F₅)₂, LiN(SO₂CF₃)(COCF₃), Li(C₄F₉SO₃), LiC(SO₂CF₃)₃, and Li₂B₁₀Cl₁₀.

One of the above electrolytes may be used alone or two or more types thereof may be used in combination.

Any organic solvent known in the art can be selected as the organic solvent, and examples thereof include carbonates such as propylene carbonate, ethylene carbonate, dimethyl carbonate, diethyl carbonate, ethyl methyl carbonate, 4-trifluoromethyl-1,3-dioxolan-2-one, and 1,2-di(methoxycarbonyloxy)ethane; esters such as methyl formate, methyl acetate, and γ-butyrolactone; ethers such as 1,2-dimethoxyethane, 1,3-dimethoxypropane, pentafluoropropyl methyl ether, 2,2,3,3-tetrafluoropropyl difluoromethyl ether, tetrahydrofuran, and 2-methyltetrahydrofuran; amides such as N,N-dimethylformamide and N,N-dimethylacetamide; nitriles such as acetonitrile and butyronitrile; carbamates such as 3-methyl-2-oxazolidone; and sulfur-containing compounds such as sulfolane, dimethyl sulfoxide, and 1,3-propane sultone. Any one of the above organic solvents may be used alone or two or more types thereof may be used in combination.

### (Separator)

Examples of the separator 17 include separators formed from olefin resins such as polyethylene and polypropylene, fluororesins, aromatic resins containing nitrogen atoms, and the like. Examples of the form thereof include porous membranes, nonwoven fabrics, and woven fabrics.

### (Solid Electrolyte)

Examples of a solid electrolyte of the solid electrolyte layer 27 include an inorganic solid electrolyte and an organic solid electrolyte. As the inorganic solid electrolyte and the organic solid electrolyte, those known in the art can be used. Examples of the inorganic solid electrolyte include an oxide that contains an oxygen atom and has both lithium ion conductivity and electrical insulation, and an oxide that contains a sulfur atom and has both lithium ion conductivity and electrical insulation. As the organic solid electrolyte, a polymer compound that exhibits ion conductivity can be used. For example, polyethylene oxide, polypropylene oxide, copolymers thereof, and the like can be used. Further, the organic solid electrolyte may also be in the form of a gel containing the above electrolytic solution.

### <<Method for Producing Regenerated Positive Electrode>>

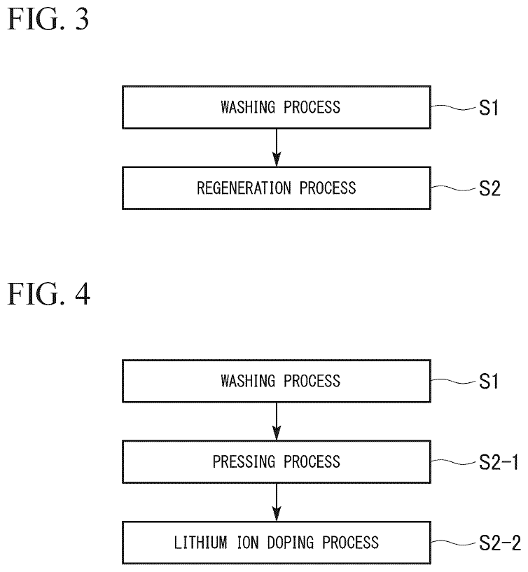

The method for producing a regenerated positive electrode includes: washing a laminate retrieved from a lithium ion secondary battery with an organic solvent (washing process); retrieving the aforementioned positive electrode from the laminate washed with the aforementioned organic solvent; and subjecting the aforementioned retrieved positive electrode to a regeneration process. FIG. 3 is a flow chart of a method for producing a regenerated positive electrode according to the first embodiment of the present invention.

### <Washing Process>

In a washing process S1, a laminate is washed with an organic solvent.

The organic solvent is preferably a polar organic solvent. Examples of such an organic solvent include a protic polar solvent and an aprotic polar solvent, and an aprotic polar solvent is preferred.

Examples of the protic polar solvent include alcohols such as methanol, ethanol, n-propanol, isopropanol, 1-butanol, and 2-butanol; carboxylic acids such as formic acid, acetic acid, and propionic acid; and glycols such as ethylene glycol and propylene glycol.

Examples of the aprotic polar solvent include ethers such as dimethyl ether, diethyl ether, tetrahydrofuran, and ethylene glycol dimethyl ether; ketones such as acetone, methyl ethyl ketone, and cyclohexanone; esters such as ethyl acetate; carbonates such as ethyl methyl carbonate, dimethyl carbonate, diethyl carbonate, and ethylene carbonate; and organic solvents containing nitrogen atoms or sulfur atoms such as pyridine, dimethyl sulfoxide, acetonitrile, 1,4-dioxane, and 1,3-dioxolane.

Among these, at least one organic solvent selected from the group consisting of ketones and carbonates is preferred, and at least one organic solvent selected from the group consisting of acetone and dimethyl carbonate is more preferred.

Any one of the above organic solvents may be used alone or two or more types thereof may be used in combination.

The washing process S1 is performed by immersing the positive electrode in the organic solvent. Further, it can also be carried out while performing an ultrasonic process. By performing the ultrasonic process, it is possible to wash even the inside of the positive electrode active material. That is, the organic solvent can penetrate evenly into the inside of the positive electrode active material for washing.

The washing time is preferably from 10 to 100 minutes, and more preferably from 20 to 60 minutes. When the washing time by ultrasonic process is equal to or more than the above lower limit value, the organic solvent can penetrate evenly into the inside of the positive electrode active material. When the washing time by ultrasonic process is equal to or less than the above upper limit value, deterioration of the positive electrode active material layer due to heat generated by ultrasonic waves can be suppressed.

It is preferable to dry the positive electrode after washing. The drying may be performed under any of vacuum, reduced pressure, and normal pressure conditions. In the case of reduced pressure or normal pressure, the drying atmosphere may be an inert atmosphere such as nitrogen and argon, or an air atmosphere.

The drying temperature is preferably, for example, from 10 to 80° C., and more preferably from 15 to 50° C.

The drying time is preferably, for example, from 10 to 120 minutes, and more preferably from 20 to 60 minutes.

When a lithium ion secondary battery is used, the electrolytic solution reacts with lithium ions on the positive electrode to form a thin film containing lithium on the positive electrode. The resistance of the lithium ion secondary battery increases by this type of thin film. By carrying out the washing process S1, the above thin film is removed, and as a result, the increased resistance of the lithium ion secondary battery is restored.

It is preferable that the washing process S1 is carried out prior to other regeneration processes. Then, the positive electrode is retrieved from the laminate after the washing process S1, and is subjected to other regeneration processes. In the method for producing a regenerated positive electrode of the present embodiment, as long as the regeneration process is carried out after the washing process S1, other processes may be carried out between the washing process S1 and the regeneration process.

### <Form of Laminate>

A form of the laminate of the lithium ion secondary battery according to the present embodiment can be applied to any of the conventionally known forms and structures, such as wound type (cylindrical type) batteries, layer-built type (flat type) batteries, and flat-wound type (rectangular type) batteries. Among these, wound (cylindrical) batteries and flat-wound (rectangular) batteries are preferred, and wound (cylindrical) batteries are still more preferred. The reasons are explained below.

### <Mechanism of Action>

In the method for producing a regenerated positive electrode according to the present embodiment, the washing process S1 is carried out prior to other regeneration processes. By washing the positive electrode with an organic solvent, it is possible to recover from the increase in resistance due to a lithium-containing thin film formed on the positive electrode. In addition, in the method for producing a regenerated positive electrode according to the present embodiment, the laminate is washed. Since the positive electrode is in a sheet form, large equipment is required when washing the positive electrode retrieved from the laminate, and the amount of organic solvent used or the amount of waste liquid increases. On the other hand, since the laminate is smaller than the positive electrode, the washing can be carried out in a small facility, and the amount of organic solvent used or the amount of waste liquid is also reduced, making it more efficient and economical. In addition, the regeneration process described below needs to be carried out by retrieving the positive electrode, however the washing process

S1 does not necessarily require the positive electrode to be retrieved. By carrying out the washing process S1 first, it becomes possible to wash the laminate.

### <Regeneration Process>

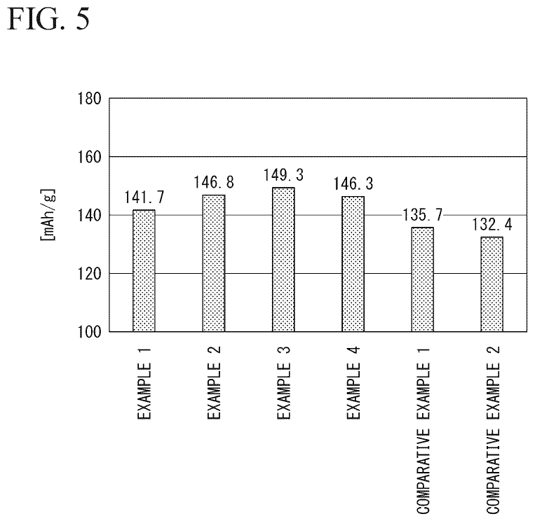

Examples of the regeneration process include a regeneration process other than the washing process, and among these, pressing the positive electrode (hereinafter also referred to as a “pressing process”) and doping the positive electrode with lithium ions (hereinafter also referred to as a “lithium ion doping process”) are preferred. It should be noted that it is preferable to carry out the pressing process and the lithium ion doping process in the order of pressing process and lithium ion doping process. FIG. 4 is a flow chart of a method for producing a regenerated positive electrode according to another first embodiment of the present invention.

### <Pressing Process>

In a pressing process S2-1, a positive electrode 13 (23) retrieved from the laminate after the washing process S1 is pressed in the thickness direction of the positive electrode 13 (23). The pressing can be performed by a known means such as a roll press. The pressing pressure is preferably set so that the thickness of the positive electrode after pressing is 85 to 100% of the thickness of the positive electrode before use (positive electrode at the time of production), and more preferably set so that the thickness of the positive electrode after pressing is 95 to 100% of the thickness of the positive electrode before use (positive electrode at the time of production).

In the pressing process S2-1, it is preferable to perform pressing while heating. By performing pressing while heating, the binder contained in the positive electrode active material layer can be softened, making it easier to regenerate the adhesive force. The heating temperature is, for example, preferably equal to or higher than the melting point of the binder and equal to or lower than 200° C., and more preferably equal to or higher than the melting point and equal to or lower than 170° C.

The pressing is preferably performed until the thickness of the positive electrode (positive electrode at the time of production) before use is reached. When charging and discharging is repeated in a lithium ion secondary battery, the degree of adhesion between the particles of the positive electrode active material and the particles of the conductive auxiliary agent decreases, thereby causing the thickness to increase and the resistance to increase. In the pressing process S2-1, by performing the pressing, the degree of adhesion between the particles of the positive electrode active material and the particles of the conductive auxiliary agent is improved, and as a result, the resistance is reduced, thereby restoring the function of the positive electrode.

The thickness of the positive electrode before use is preferably obtained in advance.

If there is information on the thickness of the positive electrode at the time of producing the lithium ion secondary battery, that information is used for the thickness of the positive electrode before use (positive electrode at the time of production). If the above information is not available, for example, a thickness obtained by excluding a void portion of a positive electrode portion from the thickness of the used positive electrode may be used as an estimated thickness.

The pressing process S2-1 preferably further includes applying a conductive agent onto the surface of the positive electrode 13 (23). The conductive agent is not particularly limited, however may be, for example, a carbonaceous material such as acetylene black and carbon nanotubes. A carbon fiber is preferred as the conductive agent. By applying the conductive agent, the conductivity can be compensated by the addition of the conductive agent, and the resistance of the positive electrode active material layer can be reduced.

A method for applying the conductive agent is not particularly limited. For example, a dispersion liquid in which the conductive agent is dispersed may be applied and dried. Further, in an application step, it is preferable to apply ultrasonic waves. By applying ultrasonic waves, the conductive agent can be caused to penetrate into voids in the positive electrode 13 (23), and the resistance can be further reduced. This can further improve and restore the state of the positive electrode.

Application of the conductive agent is preferably carried out before pressing the positive electrode 13 (23). In other words, it is preferable to press the positive electrode 13 (23) after applying the conductive agent onto the surface of the positive electrode 13 (23).

### <Lithium Ion Doping Process>

A lithium ion doping process S2-2 is performed by discharging in an electrolytic solution using a lithium electrode as a counter electrode. The lithium electrode is not particularly limited as long as it is an electrode containing lithium, and examples thereof include a lithium metal, a lithium alloy, and a lithium metal oxide, and a lithium metal is preferred. Further, the above electrode may also be in a form to be fixed to a current collector. The materials described for the positive electrode current collector and the negative electrode current collector can be used as a current collector. The electrolytic solution described above can be used as an electrolytic solution.

The positive electrode 13 (23) and the lithium electrode are energized in the electrolytic solution. More specifically, a discharge current is caused to flow from the lithium electrode to the positive electrode to discharge. At that time, lithium ions move from the lithium electrode to the positive electrode 13 (23), and the positive electrode 13 (23) is doped with lithium ions.

When a lithium ion secondary battery is used, the electrolytic solution reacts with the lithium ions on the negative electrode to form a thin film containing lithium on the negative electrode. Further, a portion of the lithium ions are also captured by the separator 17 and the solid electrolyte layer 27. Such a reduction in the lithium ions in the positive electrode causes a decrease in the capacitance of the lithium ion secondary battery. By carrying out the lithium ion doping process S2-2, the amount of lithium ions in the positive electrode is restored, and as a result, the capacitance of the lithium ion secondary battery is also restored.

The discharge conditions are not particularly limited, however for example, the discharge conditions may be set so as to achieve the capacitance of the positive electrode before use (the positive electrode at the time of production). For example, when the capacitance of the positive electrode before use (the positive electrode at the time of production) is x (Ah), either one or both of the discharge current and the discharge time may be adjusted so that a product y×z (Ah) of the discharge current y (A) and the discharge time z (h) becomes x (Ah).

### <Mechanism of Action>

In the method for producing a regenerated positive electrode of the present embodiment, by pressing the positive electrode, it is possible to recover from the increase in resistance due to the decrease in the degree of adhesion between the particles and the like of the positive electrode active material. In addition, by doping the aforementioned pressed positive electrode with lithium ions, it is possible to recover from the capacitance decrease due to the reduction of lithium in the positive electrode. Furthermore, in the method for producing a regenerated positive electrode according to the present embodiment, the pressing process S2-1 and the lithium ion doping process S2-2 are performed in this order. In the lithium ion doping process S2-2, when the positive electrode is rounded (wound type (cylindrical type) battery) or the positive electrode is creased (flat-wound type (rectangular type) battery), the doping of lithium ions may not be performed uniformly. A positive electrode that cannot be uniformly doped with lithium ions may have to be discarded from the viewpoint of performance, and the yield decreases. In addition, although it is possible to flatten the positive electrode in carrying out the lithium ion doping process S2-2, it is not efficient because the use of a jig or the like is required in order to flatten the positive electrode. On the other hand, in the method for producing a regenerated positive electrode according to the present embodiment, since the lithium ion doping process S2-2 is performed in a state in which the positive electrode is flattened by the pressing process S2-1, the doping of lithium ions is easily performed uniformly. Further, in the lithium ion doping process S2-2, the use of a jig or the like for flattening the positive electrode is unnecessary, or the jig can be simplified, which makes it efficient.

While preferred embodiments of the invention have been described and illustrated above, it should be understood that these are exemplary of the invention and are not to be considered as limiting. Additions, omissions, substitutions, and other modifications can be made without departing from the scope of the present invention. Accordingly, the invention is not to be considered as being limited by the foregoing description, and is only limited by the scope of the appended claims.

### <Preferred Aspects of Method for Producing Regenerated Positive Electrode of Present Embodiment>

A first example of a preferred aspect of the method for producing the regenerated positive electrode of the present embodiment includes a washing process, a pressing process, and a doping process. In the first example, the washing process, the pressing process, and the doping process are performed in this order.

A second example of a preferred aspect of the method for producing the regenerated positive electrode of the present embodiment includes a washing process, a doping process, and a pressing process. In the second example, the washing process, the doping process, and the pressing process are performed in this order.

A third example of a preferred aspect of the method for producing the regenerated positive electrode of the present embodiment includes a doping process, a washing process, and a pressing process. In the third example, the doping process, the washing process, and the pressing process are performed in this order.

A fourth example of a preferred aspect of the method for producing the regenerated positive electrode of the present embodiment includes a washing process and a doping process. In the fourth example, the washing process and the doping process are performed in this order.

When washing is carried out first, the laminate retrieved from the lithium ion secondary battery may be washed, or the positive electrode retrieved from the lithium ion secondary battery may be washed.

On the other hand, the pressing process and doping process are carried out on the positive electrode.

### EXAMPLES

The present invention will be described in more detail below with reference to Examples and Comparative Examples, however the present invention is not limited to the following Examples.

### Example 1

A used lithium ion secondary battery was disassembled, and a laminate having a positive electrode, a separator, and a negative electrode was retrieved from the lithium ion secondary battery.

The positive electrode used was composed of an aluminum foil as a positive electrode current collector, and a positive electrode active material layer provided on one side of the positive electrode current collector and containing a positive electrode active material, a conductive auxiliary agent, and a binder. Lithium nickel cobalt manganese oxide was used as the positive electrode active material. Carbon black was used as the conductive auxiliary agent. Polyvinylidene fluoride was used as the binder.

A porous membrane made of polyethylene was used as the separator.

A liquid electrolyte was used as the electrolyte.

The negative electrode used was composed of an aluminum foil as a negative electrode current collector, and a negative electrode active material layer provided on one side of the negative electrode current collector and containing a negative electrode active material, a conductive auxiliary agent, and a binder. Graphite was used as the negative electrode active material. Carbon black was used as the conductive auxiliary agent. Polyvinylidene fluoride was used as the binder.

The laminate was then washed with acetone. The laminate was washed by ultrasonic wave treatment using an ultrasonic wave washer for 20 minutes (washing process).

Next, the positive electrode was retrieved from the laminate after washing, and the positive electrode was dried in an air atmosphere at 50° C. for 20 minutes.

The dried positive electrode was then pressed in the thickness direction of the positive electrode using a roll press (pressing process).

The pressed positive electrode was then doped with lithium ions (doping process). In detail, a discharge current was passed from a lithium electrode (lithium metal) serving as a counter electrode to the positive electrode in the electrolytic solution to discharge, and the positive electrode was doped with lithium ions to obtain a regenerated positive electrode.

### Example 2

The laminate was retrieved from the lithium ion secondary battery in the same manner as in Example 1.

The laminate was then washed (washing process) in the same manner as in Example 1.

The positive electrode retrieved from the laminate was then dried in the same manner as in Example 1.

The washed positive electrode was then doped with lithium ions (doping process) in the same manner as in Example 1.

The doped positive electrode was then pressed (pressing process) in the same manner as in Example 1 to obtain a regenerated positive electrode.

### Example 3

The laminate was retrieved from the lithium ion secondary battery in the same manner as in Example 1, and further the positive electrode was retrieved from the laminate.

The positive electrode was then doped with lithium ions (doping process) in the same manner as in Example 1.

The doped positive electrode was then washed (washing process) in the same manner as in Example 1.

The washed positive electrode was then dried in the same manner as in Example 1.

The dried positive electrode was then pressed (pressing process) in the same manner as in Example 1 to obtain a regenerated positive electrode.

### Example 4

The laminate was retrieved from the lithium ion secondary battery in the same manner as in Example 1.

The laminate was then washed (washing process) in the same manner as in Example 1.

The positive electrode retrieved from the laminate was then dried in the same manner as in Example 1.

The washed positive electrode was then doped with lithium ions (doping process) in the same manner as in Example 1 to obtain a regenerated positive electrode.

### Comparative Example 1

The laminate was retrieved from the lithium ion secondary battery in the same manner as in Example 1, and further the positive electrode was retrieved from the laminate.

The positive electrode was then doped with lithium ions (doping process) in the same manner as in Example 1 to obtain a regenerated positive electrode.

A used lithium ion secondary battery was disassembled, a laminate having a positive electrode, a separator, and a negative electrode was retrieved from the lithium ion secondary battery, and further the positive electrode was retrieved from the laminate.

### Evaluation

### (1) Battery Capacity Measurement

A lithium ion secondary battery including a laminate having a positive electrode, a separator, a liquid electrolyte, and a negative electrode was produced.

As the positive electrode, any one of the regenerated positive electrodes of Examples 1 to 4, the regenerated positive electrode of Comparative Example 1, and the positive electrode of Comparative Example 2 was used.

The separator used was the same as in Example 1.

The liquid electrolyte used was the same as in Example 1.

The negative electrode used was the same as in Example 1.

The capacity of the resulting secondary battery was measured. The results are shown in FIG. 5.

(2) Measurement of resistance of positive electrode

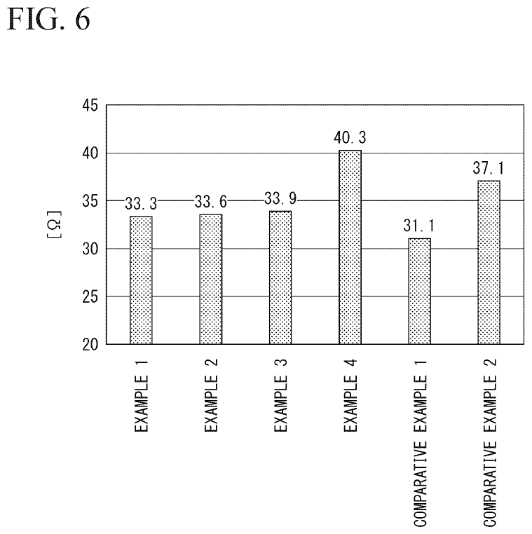

The resistance of any one of the regenerated positive electrodes of Examples 1 to 4, the regenerated positive electrode of Comparative Example 1, or the positive electrode of Comparative Example 2 was measured. The results are shown in FIG. 6.

As shown in FIG. 5, when comparing Comparative Example 1 in which no washing process was performed with Examples 1 to 4 in which washing process was performed, it was found that the washing process was effective in recovering the capacity of the lithium ion secondary battery.

Furthermore, when comparing Comparative Example 1 with Comparative Example 2, it was found that simply doping lithium ions does not have the effect of restoring the capacity of a lithium ion secondary battery.

In addition, when comparing Comparative Example 1 with Example 4, it was found that the capacity recovery of the lithium ion secondary battery was large when the cleaning treatment was performed before doping with lithium ions.

Furthermore, as shown in FIG. 6, when comparing Example 4 with Examples 1, 2 and 3, performing a press treatment in addition to doping with lithium ions has the effect of reducing the resistance of the positive electrode.

From the above, it is not necessarily necessary to perform a cleaning treatment of the laminate, but performing a cleaning treatment of the laminate has a greater effect on recovering the capacity of the lithium ion secondary battery and reducing the resistance of the positive electrode.

### REFERENCE SIGNS LIST

10, 20: Lithium ion secondary battery; 11, 21: Positive electrode current collector; 12, 22: Positive electrode active material layer; 13, 23: Positive electrode; 14, 24: Negative electrode current collector; 15, 25: Negative electrode active material layer; 16, 26: Negative electrode; 17: Separator; 27: Solid electrolyte layer

What is claimed is:

1. A method for producing a regenerated positive electrode in a used lithium ion secondary battery including a laminate having a positive electrode, either one of a separator and a solid electrolyte layer, and a negative electrode,
the method comprising:
washing said laminate retrieved from said lithium ion secondary battery with an organic solvent;
retrieving said positive electrode from the laminate washed with said organic solvent; and
subjecting said retrieved positive electrode to a regeneration process.

2. A method for producing a regenerated positive electrode in a used lithium ion secondary battery including a laminate having a positive electrode, either one of a separator and a solid electrolyte layer, and a negative electrode,
the method comprising:
washing said positive electrode retrieved from said lithium ion secondary battery with an organic solvent; and
subjecting said the positive electrode washed with said organic solvent to a regeneration process.

3. The method for producing a regenerated positive electrode according to claim 1, wherein said organic solvent is an aprotic polar solvent.

4. The method for producing a regenerated positive electrode according to claim 1,
wherein said organic solvent is at least one organic solvent selected from the group consisting of a ketone and a carbonate.

5. The method for producing a regenerated positive electrode according to claim 4,
wherein said organic solvent is at least one organic solvent selected from the group consisting of acetone and dimethyl carbonate.

6. The method for producing a regenerated positive electrode according to claim 1, wherein said regeneration process comprises pressing said positive electrode.

7. The method for producing a regenerated positive electrode according to claim 6,
wherein said regeneration process further comprises doping said pressed positive electrode with lithium ions, and
the doping of said lithium ions is performed by discharging in an electrolytic solution using a lithium electrode as a counter electrode.

8. The method for producing a regenerated positive electrode according to claim 1, wherein said laminate is wound.

9. The method for producing a regenerated positive electrode according to claim 2, wherein said organic solvent is an aprotic polar solvent.

10. The method for producing a regenerated positive electrode according to claim 2,
wherein said organic solvent is at least one organic solvent selected from the group consisting of a ketone and a carbonate.

11. The method for producing a regenerated positive electrode according to claim 10,
wherein said organic solvent is at least one organic solvent selected from the group consisting of acetone and dimethyl carbonate.

12. The method for producing a regenerated positive electrode according to claim 2, wherein said regeneration process comprises pressing said positive electrode.

13. The method for producing a regenerated positive electrode according to claim 12,
wherein said regeneration process further comprises doping said pressed positive electrode with lithium ions, and
the doping of said lithium ions is performed by discharging in an electrolytic solution using a lithium electrode as a counter electrode.

14. The method for producing a regenerated positive electrode according to claim 2, wherein said laminate is wound.

15. The method for producing a regenerated positive electrode according to claim 2, further comprising subjecting the positive electrode to a regeneration process before washing with the organic solvent.
